(19) United States
(12) Patent Application Publication
(10) Pub. No.: US 2006/0021825 A1
(43) Pub. Date: Feb. 2, 2006

(54) SAFETY DEVICE FOR PREVENTING WORKER FROM FALLING

(76) Inventors: YOUNG-HWA AN, ANSAN-CITY KYUNGKI-DO (KR); KI-JUN SONG, ULSAN-CITY (KR)

Correspondence Address: IPLA P.A., 3580 WILSHIRE BLVD., 17TH FLOOR, LOS ANGELES, CA, 90010, US

(21) Appl. No.: 11/161,204

(22) Filed: Jul. 26, 2005

(30) Foreign Application Priority Data
Jul. 27, 2004 (KR) 10-2004-0058869

(51) Int. Cl. A62B 1/08

(52) U.S. Cl. 182/236

(57) ABSTRACT

A safety device for preventing a worker from falling. A box is integrally secured to the lower end of a hook which is hung on a scaffold. A reel on which a lanyard is wound, a lanyard winding unit for rotating the reel to wind the lanyard on the reel, and a shock absorbing unit for absorbing shock applied from the worker who is falling, are disposed in the box. The reel includes a lanyard winding section, a lanyard winding unit installation section, and a shock absorbing unit installation section. The shock absorbing unit comprises a steel wire which is securely connected to the lanyard, a braking tube which is closely fitted on the steel wire to perform a braking function, and a stopper ring which is firmly fastened to the steel wire at one end of the braking tube.

### BACKGROUND OF THE INVENTION

1. Field of the Invention

The present invention relates to a safety device which can prevent a worker conducting construction work at an elevated position, in particular, on scaffolding, etc., from falling.

2. Description of the Related Art

In a conventional safety device for preventing a worker from falling, a hook connected to one end of a lanyard is hung on a horizontal rail or a vertical post which constitutes the scaffolding, and the other end of the lanyard is connected to a belt worn on the worker's waist. If the worker falls off from the scaffolding while conducting construction work, the worker is restrained from falling to the ground under the action of the lanyard. In this regard, a shock absorbing unit is arranged such that the fall of the worker stops as shock applied from the worker is absorbed by the shock absorbing unit.

However, in the conventional safety device as described above, the hook hung on the scaffolding, the lanyard connected to the hook, the shock absorbing unit formed by folding and stitching the lanyard a multitude of times, and a lanyard winding unit for winding a drooped portion of the lanyard and preventing the lanyard from obstructing the passage of the worker are separately provided. Therefore, defects are caused in that it is inconvenient for the worker to conduct the construction work with these component elements separately connected to the worker's belt. As a consequence, there is a tendency for a worker skilled in conducting a predetermined task on the scaffolding to be reluctant to use the safety device which serves as a kind of protection equipment.

Also, in the conventional safety device for preventing a worker from falling, the shock absorbing unit is formed by folding the lanyard to form two or more folds and then stitching the respective folds or attaching the respective folds using Velcro-brand hook and loop fastener strips so that shock applied from the worker can be absorbed as the stitched or attached folds are unfolded. In this regard, in order to ensure reliable operation of the shock absorbing unit, the worker's falling distance must be greater than a total length of the lanyard which is the sum of a first length of the lanyard for allowing free movement of the worker and a second length of the lanyard corresponding to the unfolded length of the folds constituting the shock absorbing unit. Consequently, because the total length of the lanyard exceeds a height of one story of a building, in the case that the worker conducts the predetermined task on the second floor, the safety device cannot but lose its functionality as safety equipment.

### SUMMARY OF THE INVENTION

Accordingly, the present invention has been made in an effort to solve the problems occurring in the related art, and an object of the present invention is to provide a safety device for preventing a worker from falling, which is constructed to be conveniently used by simply hanging a hook on a scaffold, and in which a shock absorbing unit is structured to occupy a reduced space so that the shock absorbing unit can be received in the box having a small size, whereby the entire safety device has a compact configuration to ensure convenient use and improve efficiency of work.

In order to achieve the above object, according to one aspect of the present invention, there is provided a safety device for preventing a worker from falling, wherein a box is integrally secured to the lower end of a hook which is hung on a scaffold, and wherein a reel on which a lanyard is wound, a lanyard winding unit for rotating the reel to wind the lanyard on the reel, and a shock absorbing unit for absorbing shock applied from the worker who is falling, are disposed in the box.

According to another aspect of the present invention, the reel includes a lanyard winding section, a lanyard winding unit installation section, and a shock absorbing unit installation section.

According to still another aspect of the present invention, the shock absorbing unit comprises a steel wire which is securely connected to the lanyard, a braking tube which is closely fitted on the steel wire to perform a braking function, and a stopper ring which is firmly fastened to the steel wire at one end of the braking tube.

### BRIEF DESCRIPTION OF THE DRAWINGS

The above objects, and other features and advantages of the present invention will become more apparent after a reading of the following detailed description when taken in conjunction with the drawings, in which:

FIG. 1 is a perspective view illustrating a safety device for preventing a worker from falling in accordance with an embodiment of the present invention;

FIG. 2 is a cross-sectional view illustrating the safety device for preventing a worker from falling according to the present invention, wherein a stopper ring which is arranged at an end of a braking tube is illustrated in a perspective view;

FIG. 3 is a cross-sectional view illustrating a state in which a lanyard is paid off from the safety device for preventing a worker from falling according to the present invention, wherein the stopper ring which is arranged at the end of the braking tube is illustrated in a perspective view; and

FIG. 4 is a perspective view independently illustrating a shock absorbing unit which constitutes a main component element of the safety device for preventing a worker from falling according to the present invention.

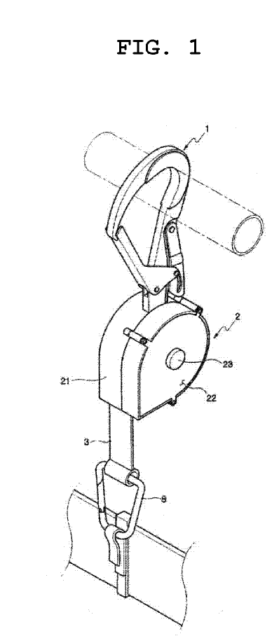

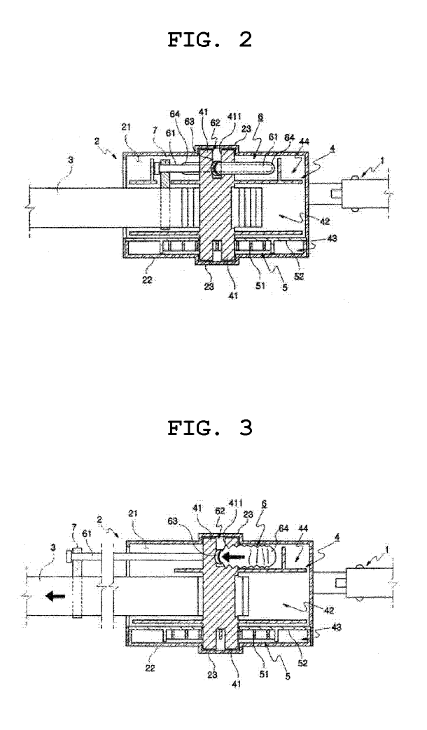

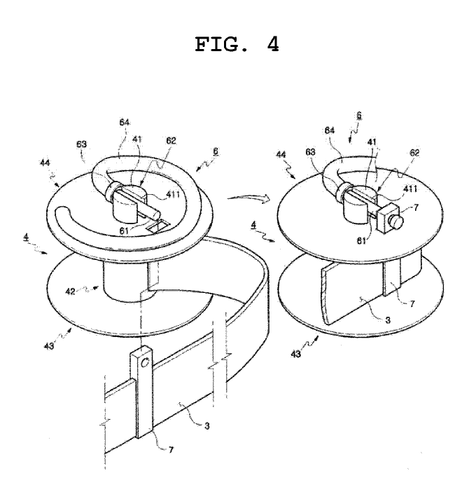

### DETAILED DESCRIPTION OF PREFERRED EMBODIMENTS

Reference will now be made in greater detail to a preferred embodiment of the invention, an example of which is illustrated in the accompanying drawings. Wherever possible, the same reference numerals will be used throughout the drawings and the description to refer to the same or like parts.

In a safety device for preventing a worker from falling in accordance with an embodiment of the present invention, a box 2 is integrally secured to the lower end of a hook 1 which is hung on a scaffold. A reel 4 on which a lanyard 3 is wound, a lanyard winding unit 5 for rotating the reel 4 to wind the lanyard 3 on the reel 4, and a shock absorbing unit 6 for absorbing shock applied from the worker who is falling, are disposed in the box 2.

The box 2 has a casing 21 for receiving the reel 4 and a cover 22 for closing the casing 21. The casing 21 and the cover 22 are formed with a pair of bearing sections 23 into which both ends of the shaft 41 of the reel 4 are rotatably fitted, respectively.

Concretely speaking, in the reel 4, both ends of the shaft 41 are rotatably fitted into the bearing sections 23 of the casing 21 and cover 22, respectively. The reel 4 is installed in a manner such that the body of the reel 4 can rotate about the shaft 41. The reel 4 includes a lanyard winding section 42, a lanyard winding unit installation section 43, and a shock absorbing unit installation section 44.

A lanyard winding unit 5 is installed on the lanyard winding unit installation section 43 of the reel 4. The lanyard winding unit 5 comprises a spring 51. One end of the spring 51 is affixed to the shaft 41 of the reel 4, and the other end of the spring 51 is affixed to the box 2. In this embodiment as illustrated in the attached drawings, the other end of the spring 51 is affixed to an inner plate 52 which is fixedly installed in the box 2. In a state in which the spring 51 is adequately loosened, a sufficient length of the lanyard 3 is wound on the lanyard winding section 42. Accordingly, if the lanyard 3 is pulled to be unwound, as the lanyard winding unit installation section 43 rotates in a forward direction, the spring 51 is tensed. Then, in this state, if the lanyard 3 is released, as the lanyard winding unit installation section 43 is rotated in a backward direction by elastic force of the spring 51, the lanyard 3 is wound again on the reel 4.

A shock absorbing unit 6 is installed on the shock absorbing unit installation section 44 of the reel 4. The shock absorbing unit 6 is structured as described below.

The shock absorbing unit 6 comprises a steel wire 61 which is securely connected to the lanyard 3, a groove 62 which is defined through an end of the shaft 41 of the reel 4 to extend in a diametric direction of the shaft 41 and through which the steel wire 61 passes, a stopper ring 63 which is movably fitted around the steel wire 61 outside the groove 62, and a braking tube 64 which is substantially closely fitted on the steel wire 61 to perform a braking function by being squeezed against the stopper ring 63. It is preferred that the steel wire 61 comprise a rope which is formed by twisting a plurality of wires and has a diameter of 3 mm. Also, it is preferred that the groove 62 comprise a trench 411 which is defined through the end of the shaft 41 of the reel 4.

The stopper ring 63 is a steel ring which has an inner diameter for allowing the stopper ring 63 to freely move on the steel wire 61 and preventing the passage of the braking tube 64 through the stopper ring 63. As can be readily seen from the attached drawings, it is preferred that, as the steel wire 61 is pulled through the groove 62, the braking tube 64 is corrugated and squeezed against the stopper ring 63 which is placed on the end of the shaft 41 of the reel 4, to provide appropriate braking force.

The braking tube 64 is formed of synthetic resin having a low hardness value such that, when the steel wire 61 is pulled through the groove 62, the braking tube 64 squeezed against the stopper ring 63 is not broken but continually crushed. It is preferred that, when measured between the stopper ring 63 and the distal end of the steel wire 61, the length of the steel wire 61 around which the braking tube 64 is substantially closely fitted be no less than 30 cm. In this regard, it is preferred that the distance is no greater than 40 cm. When assuming that a worker weighing 75 Kg falls from a height of 1.5 m, impact force reaches about 1,200 Kg. Therefore, in this case, it is preferred that the braking tube 64 be crushed and squeezed against the stopper ring 63 starting from the time a load of 300˜450 Kg is applied to the steel wire 61 until the entire braking tube 64 is completely corrugated through the length of 30 cm, to effectively absorb the shock applied from the worker who is falling. To this end, it is preferred that the braking tube 64 be formed by coating polyethylene of 1.5˜2 mm on the steel wire 61 which comprises a rope formed by twisting a plurality of wires and has a diameter of 3 mm. In order to improve connection strength when connecting the lanyard 3 and the steel wire 61, a separate connection element 7 can be employed.

In order to ensure that the reel 4 on which the lanyard 3 is wound, the lanyard winding unit 5 for rotating the reel 4 to wind the lanyard 3 on the reel 4, and the shock absorbing unit 6 for absorbing the shock applied from the worker who is falling, are disposed in the box 2, the box 2 must have a sufficient space for receiving these component elements. Also, in order to ensure that the lanyard 3 pulls the steel wire 61 through the connection element 7 when a worker falls and the shock absorbing unit 6 operates, it is preferred that the reel 4 is made of synthetic resin so that the remaining portion of the reel 4 except for the shaft 41 can be easily broken and thereby the operation of the connection element 7 is not adversely influenced by the presence of the reel 4.

A connection ring 8 for connecting the lanyard 3 to the worker's belt is provided to an end of the lanyard 3.

In the safety device for preventing a worker from falling according to the present invention, constructed as mentioned above, in a state in which the connection ring 8 is connected to the worker's belt and the hook 1 is hung on a scaffold or a rod member, the worker can start working. If the worker moves on the scaffolding, the lanyard 3 is pulled. The lanyard 3 pulled in this way rotates the lanyard winding section 42, as a result of which the lanyard 3 is unwound. As the lanyard 3 is unwound, the spring 51 is tensed. When the work is finished, if the hook 1 is removed from the scaffold, the tensed spring 51 is loosened again and the lanyard 3 is wound on the lanyard winding section 42.

In the case that the worker wearing the safety device according to the present invention falls while conducting construction work, the lanyard 3 is paid off and the connection element 7 is pulled, whereby the connection element 7 breaks the reel 4 and pulls the steel wire 61.

The steel wire 61 pulls the stopper ring 63 toward the groove 62. As the stopper ring 63 is brought into contact with the end of the shaft 41 of the reel 4 in which the groove 62 is defined, the movement of the stopper ring 63 is stopped, and only the steel wire 61 is pulled through the groove 62. As the steel wire 61 is continuously pulled through the groove 62, the braking tube 64 is crushed and squeezed against the stopper ring 63 to provide resistant force for resisting the movement of the steel wire 61. This resistance against the movement of the steel wire 61 occurs over the entire length of about 30 cm of the steel wire 61. Due to this resistance, a falling velocity of the worker is decreased to protect the worker from being injured.

As is apparent from the above description, the safety device for preventing a worker from falling according to the present invention provides advantages in that a reel on which a lanyard is wound, a lanyard winding unit for rotating the reel to wind the lanyard on the reel, and a shock absorbing unit for absorbing shock applied from a worker who is falling, are disposed in a box, and the box is integrated with a hook which is to be hung on a scaffold, whereby the safety device can be conveniently used and efficiency of work can be improved. Further, since the shock absorbing unit is structured to occupy a reduced space, the shock absorbing unit can be received in the box having a small size, whereby the safety device can have a compact configuration to ensure convenient use and improve efficiency of work.

In the drawings and specification, there has been disclosed a typical preferred embodiment of the invention and, although specific terms are employed, they are used in a generic and descriptive sense only and not for purposes of limitation, the scope of the invention being set forth in the following claims.

What is claimed is:

1. A safety device for preventing a worker from falling, wherein a box is integrally secured to the lower end of a hook which is hung on a scaffold, and wherein a reel on which a lanyard is wound, a lanyard winding unit for rotating the reel to wind the lanyard on the reel, and a shock absorbing unit for absorbing shock applied from the worker who is falling, are disposed in the box.

2. The safety device as set forth in claim 1, wherein the reel includes a lanyard winding section, a lanyard winding unit installation section, and a shock absorbing unit installation section.

3. The safety device as set forth in claim 1, wherein the shock absorbing unit comprises a steel wire which is securely connected to the lanyard, a braking tube which is closely fitted on the steel wire to perform a braking function, and a stopper ring which is firmly fastened to the steel wire at one end of the braking tube.
